(19) United States
(12) Patent Application Publication
(10) Pub. No.: US 2010/0194879 A1
(43) Pub. Date: Aug. 5, 2010

(54) OBJECT MOTION CAPTURING SYSTEM AND METHOD

(75) Inventors: Willem Franke Pasveer, Eindhoven (NL); Victor Martinus Gerardus Van Acht, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/667,397

(22) PCT Filed: Jul. 9, 2008
(86) PCT No.: PCT/IB08/52751

§ 371 Date: Dec. 31, 2009

(30) Foreign Application Priority Data
Jul. 10, 2007 (EP) 07112188.3

(51) Int. Cl. H04N 7/18

(52) U.S. Cl. 348/135; 348/E07.085

(57) ABSTRACT

In a system and method of capturing movement of an object, a tracking device is used having an optical marker and a motion sensor providing motion data representative of the position and orientation of the tracking device. The tracking device is connected to the object, and motion of the optical marker is registered by a camera to thereby provide video data representative of the position of the tracking device. The motion data and the video data are processed in combination to determine the position and orientation of the tracking device in space over time.

### FIELD OF THE INVENTION

The present invention relates to a system and method of capturing motion of an object.

### BACKGROUND OF THE INVENTION

In many fields, such as the field of sports, the field of healthcare, the field of movies and animation, and the field of rehabilitation, capturing a motion of a moving object plays a vital role. Once the motion has been captured, different motion characteristics can be determined, such as position in time, velocity, acceleration, distance, time of flight, spin rate and so on. The object may be a person, an animal, a plant or any non-living device. The motion may be a motion of the object as a whole, or a motion of a part of the object, or a combination of such motions, where different parts of the object may perform different motions at the same time.

Considerable technical developments have been made to capture motion in relation to sports, e.g. the motion of sportsmen and sportswomen (like athletes), the motion of sports or game objects, like a football, a baseball, a golf club, and the like.

In a first type of known system, one or more cameras are used to capture images of moving objects. The objects are provided with one or more optical markers at predetermined locations, and the one or more cameras register the positions of the markers in time. This registration in turn is used in a processing of the images to reconstruct the motions of the object in time. An example is the capture of a movement of a golf club as disclosed e.g. in U.S. Pat. No. 4,163,941. Another example is the capture of a movement of a person moving in front of the camera(s), where markers have been attached or connected to different body parts, such as the head, body, arms and legs. From the registered coordinated movements of the different markers, data processing means may extract data to provide characteristics of the movements, or to provide rendered images of the objects or related objects, simulating the original movements.

In a second type of known system, motion sensors are attached or connected to an object, or embedded therein. The motion sensor may provide signals representative of acceleration in different directions, such as three mutually orthogonal directions X, Y and Z, magnetometers providing signals representative of magnetic field in different directions, such as three mutually orthogonal directions X, Y and Z, and a timing signal. An example of the use of such motion sensors again is the capture of a movement of a golf club as disclosed e.g. in WO-A-2006/010934. The motion sensor may further contain gyroscopes in X, Y and Z directions that measure a rotational speed of the motion sensor around the X, Y, Z axis.

In the above-mentioned first type of system using one or more optical markers to capture motion of an object a problem arises when an optical marker moves out of the field of view of a camera intended to register the movement of the optical marker, or still is in the field of view of the camera but hidden (out of line-of-sight) behind another optical marker, a part of the object, or another object. In such situations, the camera is unable to track the optical marker, and the corresponding motion capture becomes incomplete or at least unreliable. A possible solution to this problem is the use of multiple cameras, however, this will not solve the problem altogether, is very expensive, and adds to the complexity of the motion capture system.

In the above-mentioned second type of system using motion sensors to capture motion of an object a problem arises when a motion sensor position cannot be determined accurately by lack of reference or calibration positions over an extended period of time. Even if an initial position of a motion sensor is calibrated, during movement of the motion sensor in time the position and orientation will very soon have such large errors that the motion sensor motion data become unreliable.

### OBJECT OF THE INVENTION

It is desirable to provide a motion capture system and method which can accurately and reliably measure motion characteristics, like position, orientation, velocity, acceleration over time, also when the object moves out of the line-of-sight of a camera.

### SUMMARY OF THE INVENTION

In an embodiment of the invention, a system of capturing movement of an object is provided, the system comprising a tracking device configured to be connected to the object. The tracking device comprises at least one optical marker, and at least one motion sensor providing motion data representative of the position and orientation of the tracking device. The system further comprises at least one camera to register motion of the optical marker to thereby provide video data representative of the position of the tracking device, and a linking data processor configured for processing the video data and the motion data in combination to determine the position and orientation of the tracking device in space over time.

The system in the embodiment of the invention allows to correct the position determined from the motion data on the basis of the position determined from the video data, thus providing a more precise position estimation of the (part of the) object over time. Even when the video data are temporarily not available, the position of the (part of the) object may still be estimated. Further, the system in the embodiment of the invention allows to correct the position determined from the video data on the basis of the position determined from the motion data.

In a further embodiment of the invention, a method of capturing movement of an object is provided, using a tracking device comprising at least one optical marker, and at least one motion sensor providing motion data representative of the position and orientation of the tracking device. In the method, the tracking device is connected to the object, motion of the optical marker is registered by a camera to thereby provide video data representative of the position of the tracking device; and the motion data and the video data are processed in combination to determine the position and orientation of the tracking device in space over time.

The claims and advantages will be more readily appreciated as the same becomes better understood by reference to the following detailed description and considered in connection with the accompanying drawings in which like reference symbols designate like parts.

### BRIEF DESCRIPTION OF THE DRAWINGS

FIG. 1 schematically illustrates an embodiment of a system of the present invention.

### DETAILED DESCRIPTION OF EXAMPLES

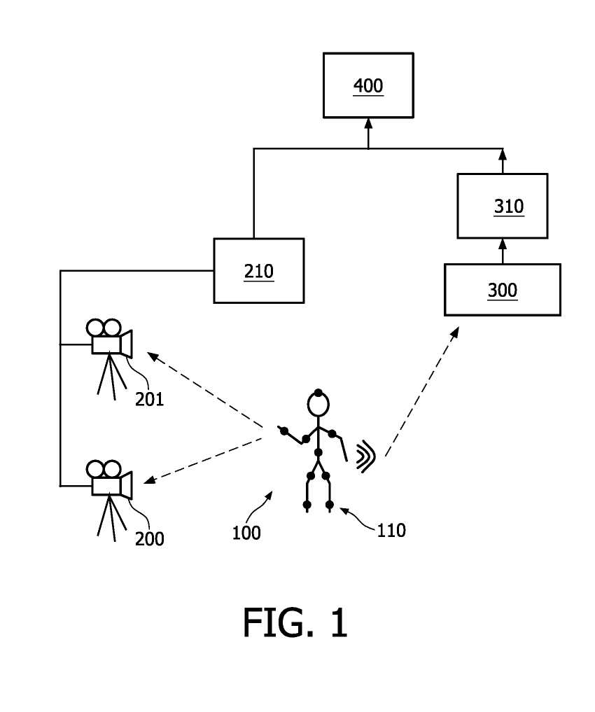

FIG. 1 shows a diagram indicating components of a system of capturing motion of an object 100. In the example of FIG. 1, the object 100 is to represent a person. However, the object 100 may also be an animal, a plant, or a device. The object may be moving as a whole, such as performing a translational and/or rotational movement, and/or the object may have different parts moving relative to each other. The following description will focus on a person moving, but it will be clear that the system described is not limited to capturing motion of a person.

The object 100 as shown in FIG. 1 has different parts movable relative to each other, such as a head, a body, arms and legs. As schematically indicated, by way of example the head and the body of the object 100 are each provided with one tracking device 110, whereas each arm and each leg are provided with two tracking devices 110.

The tracking device 110 comprises a motion sensor. The motion sensor may comprise at least one accelerometer providing an acceleration signal representative of the acceleration of the tracking device, or a plurality of accelerometers (e.g. three accelerometers) measuring accelerations in mutually orthogonal directions and providing acceleration signals representative of the acceleration of the respective accelerometers. The motion sensor further may comprise at least one magnetometer measuring the earth's magnetic field in a predetermined direction and providing an orientation signal representative of the orientation of the tracking device, or a plurality of magnetometers (e.g. three magnetometers) measuring the earth's magnetic field in mutually orthogonal directions and providing orientation signals representative of the orientation of the tracking device. The motion sensor further may comprise at least one gyroscope providing a rotation signal representative of a rotational speed of the tracking device around a predetermined axis, or a plurality of gyroscopes (e.g. three gyroscopes) measuring rotational speeds in mutually orthogonal directions and providing rotation signals representative of the rotational speeds of the tracking device around axes in the respective orthogonal directions. The tracking device 110 further comprises a timer providing a timing signal.

In practice, it is not necessary for the motion sensor of the tracking device 110 to generate signals from three (orthogonally directed) accelerometers and three (orthogonally directed) magnetometers in order to determine the position and orientation of the tracking device 110 in three dimensions from said signals. Using assumptions well known to the skilled person, the position and orientation of the tracking device 110 may also be determined from signals from three accelerometers and two magnetometers, or signals from two accelerometers and three magnetometers, or signals from two accelerometers and two magnetometers, or from signals from two accelerometers and one magnetometer, or from signals from three gyroscopes, or from signals from other combinations of accelerometers, magnetometers and gyroscopes.

The tracking device 110 is configured to provide a motion signal carrying motion data representative of an identification (hereinafter: motion identification), a position, and an orientation of the tracking device 110, the motion signal comprising the signals output by one or more accelerometers, one or more magnetometers, and/or one or more gyroscopes at specific times determined by the timer. The motion data may be transmitted in wireless communication, although wired communication is also possible.

The motion data are received by receiver 300, and output to and processed by data processor 310 to determine the position and orientation of the tracking device 110.

The tracking device 110 carries an optical marker, such as a reflective coating or predetermined colour area in order to have a good visibility for cameras 200, 201. The cameras may be configured to detect visible light and/or infrared light. The cameras 200, 201 detect movements of the optical markers of the tracking devices 110, and are coupled to a video processing system 210 for processing video data output by the cameras 200, 201. In the video processing system 210, each tracking device 110 has an identification (hereinafter: video identification) assigned to it being identical to, or corresponding to the motion identification contained in the motion signal generated by the tracking device 110. Thus, by means of detection of an optical marker in the video data, the video processing system 210 provides positions of tracking devices 110 in time.

The cameras 200, 201 and the video processing system 210 are used for precise initialization and update of position coordinates of the motion sensors 110, by linking the video data of a specific tracking device (identified by its video identification) output by the video processing system 210 and obtained at a specific time, to the motion data of the same tracking device (identified by the motion identification) output by data processor 310, obtained at the same time. The linking is performed in a linking data processor 400, which provides position data and orientation data to one or more further processing devices for a specific purpose.

The initialization of position coordinates involves a first setting of the momentary position coordinates for the motion sensors of the tracking devices 110 to position coordinates determined from the video data for the optical markers of the same motion sensors at the same time. New position coordinates of the motion sensors of the tracking devices 110 will then be calculated from the motion data with respect to the first set position coordinates, and will contain errors in the course of time due to inaccuracies of the calculation and the measurements made by the one or more accelerometers, magnetometers and/or gyroscopes of the motion sensors of the tracking devices 110.

The update of position coordinates involves a further, renewed setting of the momentary position coordinates of the motion sensors of the tracking devices 110 to position coordinates determined from the video data for the optical markers of the same motion sensors at the same time. Thus, errors building up in the calculation of new position coordinates of the motion sensors of the tracking devices 110 are corrected in the update, and thereby kept low. The update of position coordinates may be done at specific time intervals, if the optical marker is visible for at least one of the cameras 200, 201 at that time. If the optical marker is not visible at the time of update, only the motion data are used to determine the position and orientation of the tracking device 110 even if the video data of a specific marker are not available, thereby retaining a continuous capturing of the motion of the object 100, and enabling a reconstruction of a position and an orientation of (parts of) the object 100 in time.

In a reconstruction of position and orientation of the tracking device 110 in time from the motion data, the following algorithm is used:
(a) determine the direction and amplitude of one or more accelerations as measured by one or more respective accelerometers; and/or
(b) determine one or more orientations as measured by one or more respective magnetometers; and/or
(c) determine one or more rotational speeds as measured by one or more respective gyroscopes;
(d) if gyroscope data are available, then calculate a new estimation of the orientation of the tracking device from the former estimation of the orientation using the gyroscope data;
(e) if no gyroscope data are available, then calculate a new estimation of the orientation of the tracking device from the former estimation of the orientation using accelerometer data and/or magnetometer data;
(f) subtract gravity from the accelerometer data, if available;
(g) optionally, use a computer model of the mechanics of the object 100, and subtract centrifugal forces from the accelerometer data, if available.

As a result of performing the above-mentioned steps, the translational acceleration of the tracking device may be obtained, taking into account possible coordinate frame transformations different coordinate frames.

In step (d), a soft low-pass feedback loop may be applied over the new estimation of the orientation, incorporating measurement data of one or more accelerometers and/or one or more magnetometers, to compensate for drift of the gyroscopes.

After step (d) or (e), position information is available which can be utilized particularly well if relationships between tracking devices are known. For example, if the tracking devices are attached to a part of a human body, e.g. to an upper arm, and it is known that the arm is pointing upward, and the length of the arm is also known, then the position of the hand of the arm can be calculated relatively accurately.

The position information obtained from the motion sensors is relatively reliable for relatively high frequencies, i.e. relatively rapid changes in position of (a part of) the object. On the other hand, the position information obtained from the video cameras is relatively reliable for relatively low frequencies, since a relatively low frame rate is used in the video cameras. The linking data processor 400 may operate such that a corresponding differentiation is made in the position and orientation calculation, depending on the speed of position changes.

The video processing system 210, the data processor 310, and the linking data processor 400 each are suitably programmed, containing one or more computer programs comprising computer instructions to perform the required tasks.

According to the present invention, even if optical markers connected to objects are temporarily not visible, motion data from motion sensors of tracking devices being provided with the optical markers enable a continued measurement of a position and orientation of the tracking device.

Applications of the present invention include motion and gait analysis, where results are used for rehabilitation research and treatment. A further application may be found in gaming and movie industry. Other applications may be found in sportsman performance monitoring and advices. A still further application may be recognized in medical robotics.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

1. A system of capturing movement of an object, the system comprising:
a tracking device configured to be connected to the object, the tracking device comprising:
at least one optical marker; and
at least one motion sensor providing motion data representative of the position and orientation of the tracking device;
at least one camera to register motion of the optical marker to thereby provide video data representative of the position of the tracking device; and
a linking data processor configured for processing the video data and the motion data in combination to determine the position and orientation of the tracking device in space over time.

2. The system according to claim 1, wherein the linking data processor is configured to correct the position determined from the motion data on the basis of the position determined from the video data.

3. The system according to claim 1, wherein the linking data processor is configured to correct the position determined from the video data on the basis of the position determined from the motion data.

4. The system according to claim 1, wherein the optical marker is constituted by a reflective coating on the tracking device.

5. The system according to claim 1, wherein the tracking device further comprises a timer.

6. The system according to claim 1, wherein the motion sensor comprises at least one accelerometer.

7. The system according to claim 1, wherein the motion sensor comprises at least one magnetometer.

8. The system according to claim 1, wherein the motion sensor comprises at least one gyroscope.

9. The system according to claim 1, further comprising a wireless communication link to transfer the motion signal from the motion sensor to the data processor.

10. A method of capturing movement of an object, the method comprising:
providing a tracking device comprising:
at least one optical marker; and
at least one motion sensor providing motion data representative of the position and orientation of the tracking device;
connecting the tracking device to the object;
registering motion of the optical marker by a camera to thereby provide video data representative of the position of the tracking device; and
processing the motion data and the video data in combination to determine the position and orientation of the tracking device in space over time.

11. The method according to claim 10, wherein the processing of the motion data and the video data in combination comprises correcting the position determined from the motion data on the basis of the position determined from the video data.

12. The method according to claim 10, wherein the processing of the motion data and the video data in combination comprises correcting the position determined from the video data on the basis of the position determined from the motion data.
